(19) United States
(12) Patent Application Publication
(10) Pub. No.: US 2009/0216667 A1
(43) Pub. Date: Aug. 27, 2009

(54) Systems and methods for enterprise financial information management

(75) Inventors: Jaime Ospina, Bogota (CO); Angelica Trujillo, Bogota (CO)

Correspondence Address: CARR & FERRELL LLP, 2200 GENG ROAD, PALO ALTO, CA, 94303, US

(73) Assignee: Prevision Software, Inc.

(21) Appl. No.: 12/151,913

(22) Filed: May 8, 2008

Related U.S. Application Data
(60) Provisional application No. 61/066,658, filed on Feb. 21, 2008.

(51) Int. Cl. G06Q 10/00

(52) U.S. Cl. 705/30

(57) ABSTRACT

A system, method, and computer readable medium for enterprise financial information management is disclosed. Customized hierarchical representations are defined and associated with a business enterprise. The customized hierarchical representations include one or more nodes. A business process instance is associated with the one or more nodes. Financial data is received. The financial data is assigned to the business process instance.

### CROSS-REFERENCE TO RELATED APPLICATIONS

This application claims the benefit of U.S. Provisional Patent Application Ser. No. 61/066,658 filed on Feb. 21, 2008, entitled “Process-Based Enterprise Financial Information Management” which is hereby incorporated by reference.

### BACKGROUND

1. Field of the Invention

The present invention relates generally to business planning software, and more particularly to systems and methods for enterprise financial information management.

2. Background Art

Conventionally, enterprise planning software applications have organized their core architecture around accounting, for example, accrual-based accounting. This is even the case with Enterprise Resource Planning (“ERP”) software which seeks to integrate and express an organization's overall business process and financial data. Such accounting-based software is often limited in terms of the functionality it can offer. For example, it may lack the temporal parameters needed to support an organization's business processes in all stages—from planning to execution, control and analysis. For example, since accounting does not record future transactions, accounting-based ERP software typically does not provide transaction forecasts, even for highly-predictable business operations such as loan payments and recurring expenses, much less for uncertain future projections derived from corporate goals and targets.

Accounting practices register revenues and expenses in temporary accounts and then post the balances on permanent accounts at the end of set periods, such as quarters. Such batch processing may not be necessary with the rapid communication and data processing made available by modern computing capabilities and information technology, and may also have the effect of fragmenting information based on a typically rigid schedule of a fiscal period reporting cycle.

### SUMMARY

A system, method, and computer readable medium for enterprise financial information management is provided. Customized hierarchical representations associated with a business enterprise are defined. The customized hierarchical representations include one or more nodes. A business process instance is associated with the one or more nodes. Financial data is received. The financial data is assigned to the business process instance.

### BRIEF DESCRIPTION OF THE DRAWINGS

FIG. 1 is a block diagram of an exemplary environment for enterprise financial information management.

FIG. 2 is a block diagram of an exemplary financial management engine.

FIG. 3 is a flowchart showing an exemplary method for enterprise financial information management.

FIG. 4 is a block diagram of an exemplary customized hierarchical representation structure.

FIG. 5 is block diagram of exemplary stages of a business process instance.

FIG. 6 is a diagram of an exemplary digital device according to various embodiments.

### DETAILED DESCRIPTION

Various embodiments provide systems, methods, and computer readable mediums for business process enterprise planning. In exemplary embodiments, financial data may be associated with customized hierarchical representations, such as pre-set, modified or user-generated hierarchical representations. Quantities associated with the financial data may then be automatically allocated to the hierarchical representations by virtue of business process instances and their association with nodes of said hierarchical representations. Changes to the quantities may be tracked.

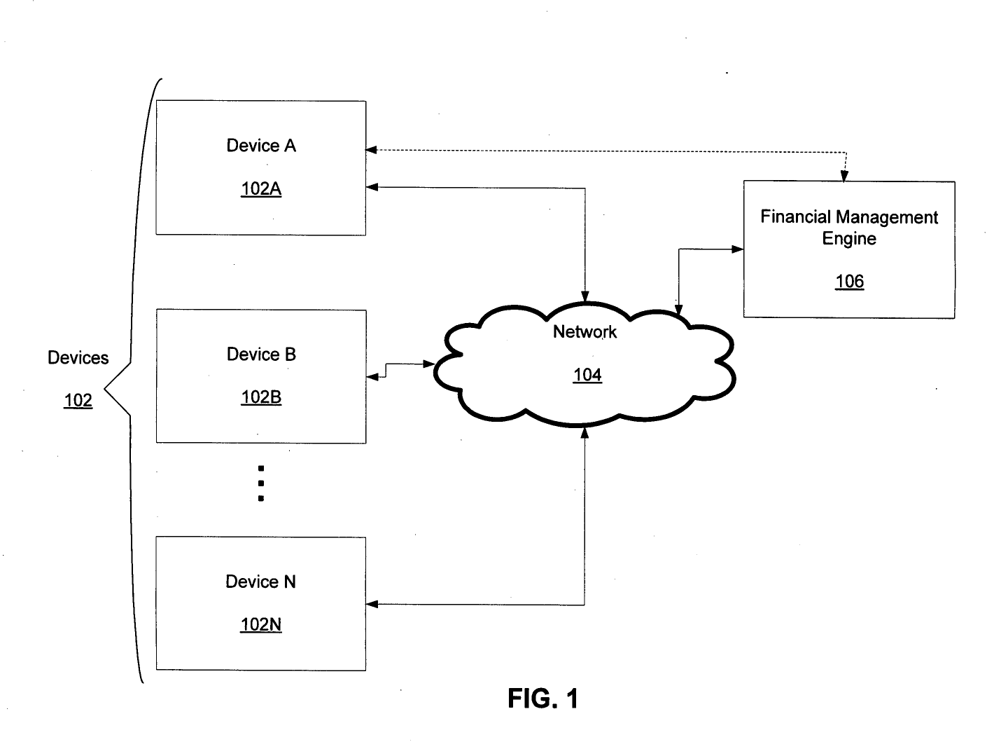

Referring now to FIG. 1, a block diagram of an exemplary environment for enterprise financial information management is shown. One or more devices 102, such as a device A 102A, a device B 102B and a device N 102N, are in communication via a network 104 with a financial management engine 106. The devices 102 may be associated with various types of users. The a financial management engine 106 may be associated with any type of business enterprise, such as corporations, corporate groups, social arrangements, conglomerates, non-profit organizations, and so forth. The financial Management Engine 106 may help to manage financial data for the various types of business enterprises. Any type of financial data for any entity may be managed utilizing the financial management engine 106.

The devices 102 may access the financial management engine 106 via the network 104, or directly. For example, the network 104 may comprise the Internet, an intranet, a peer to peer network, or any other type of network. The devices 102 may comprise any type of computing devices, such as a laptop or desktop computer, a cellular telephone, a personal digital assistant (PDA), and so forth. Similarly, the financial management engine 106 may comprise any type of device according to exemplary embodiments.

Users associated with the devices 102 define hierarchical representations associated with a business enterprise and provide financial data to the financial management engine 106, either directly, or via the network 104, as discussed herein. The financial data may include information associated with business process instances. For example, the financial data may include information concerning a loan.

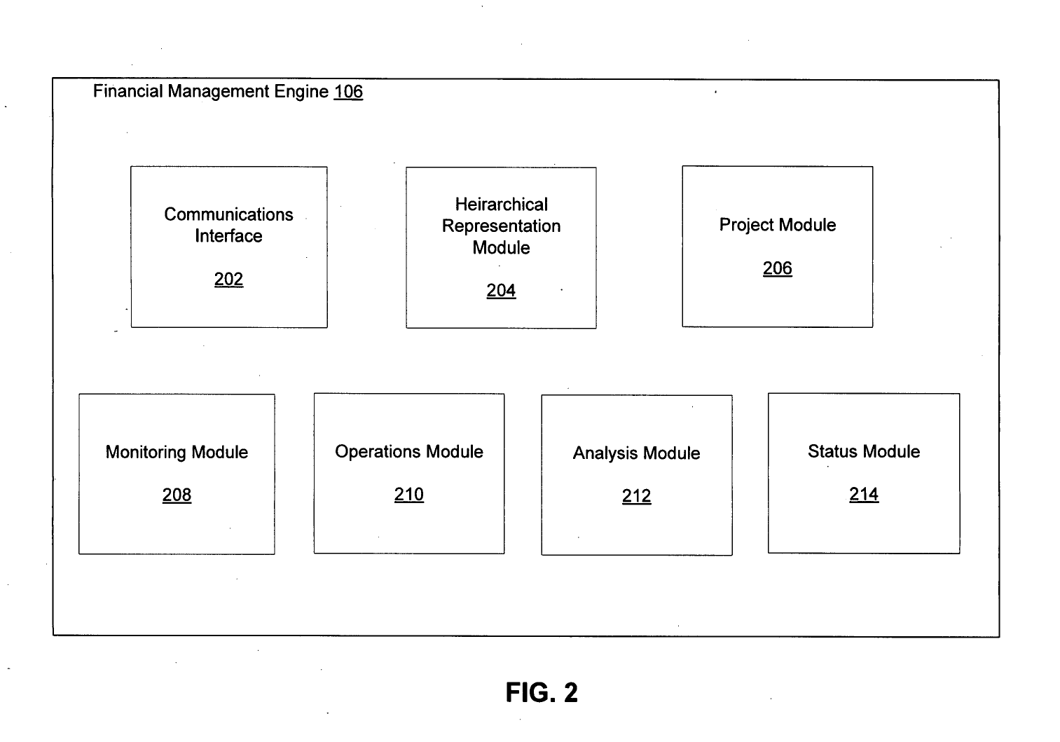

FIG. 2 is a block diagram of an exemplary financial management engine 106. The financial management engine 106 may include a communications interface 202, a customization module 204, a project module 206, a monitoring module 208, an operations module 210, an analysis module 212 and a status module 214. Although FIG. 2 describes various modules associated with the financial management engine 106, fewer or more modules may comprise the financial management engine 106 and still fall within the scope of various embodiments.

The communications interface 202 may facilitate communication between the financial management engine 106 and the devices 102. For example, users associated with the devices 102 may define hierarchical representations associated with the business enterprise, such as a company's organization, aspects of a company, a company's product categorization, and so forth, utilizing the communications interface 202. Further, financial data to be processed by the financial management engine 106 may come from the various devices 102 or from memory, storage, or a user interface associated with the financial management engine 106, itself. Financial data from the various devices 102 may also come from memory, storage or user interfaces.

The customization module 204 may be used to create and manage hierarchical representations associated with the business enterprise. The hierarchical representations can be created for any type of enterprise and may include various nodes, such as nodes for financial accounting, departments, for classifying profit centers, cost centers, customers, suppliers, products, and human resources.

Users associated with the devices 102 may define the hierarchical representations, such as by interfacing with the financial management engine 106 via the communications interface 202. The hierarchical representations may be selected from a menu, modified from a menu, and/or created by entering unique information about the hierarchical representations desired. A single business enterprise may have more than one hierarchical representation and each of the hierarchical representations may include one or more nodes. Business process instances, such as a lease, a mortgage, stocking fees, and so forth may be associated with each of the nodes.

The customization module 204 may also be utilized to define projects associated with the business enterprise. The hierarchical representations and/or the project may both be associated with the business enterprise. As discussed with respect to the hierarchical representations, the projects may be selected, modified, and/or created.

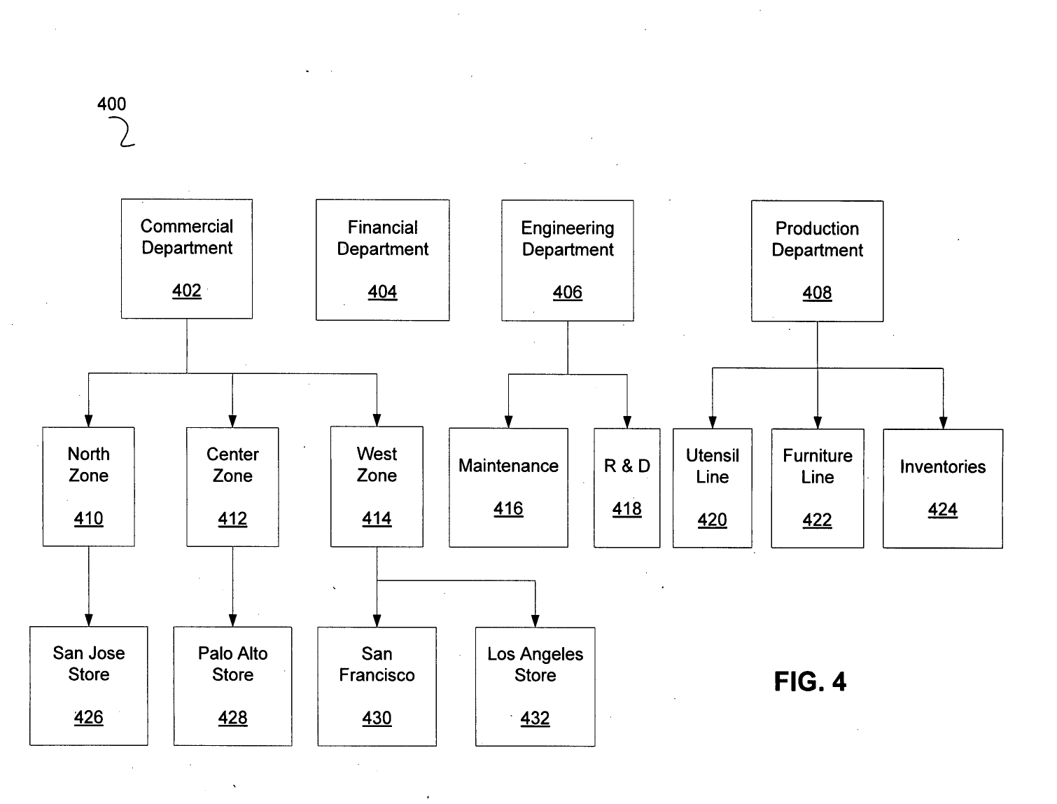

Changes to the hierarchical representations and/or the projects may be made at any time. The customization module 204 may manage and implement those changes. The hierarchical representations are discussed further in association with FIG. 4.

The operations module 210 may be used to associate a business process instance with the one or more nodes associated with the hierarchical representation. A business process instance may comprise interactions between the business enterprise and stakeholders. Stakeholders may be any person or entity that may have an interest in the business enterprise. Some examples of interactions between the business enterprise and stakeholders include the purchase of goods, sale of services, and payment of employees. The business process instances may be associated with a project to enable analysis according to a particular project, as discussed herein.

The financial data may be actual or planned. For example, the planned financial data may include scheduled mortgage payments, expected income from the sale of goods associated with a contract, and so forth. The actual financial data may include monies paid out or received, rather than planned or forecasted. For example, the actual financial data may include the mortgage payment that was sent last month and the monies received for the sale of goods last month. Any of the data from the planned financial data and/or the actual financial data may be utilized to forecast future financial data associated with the hierarchical representations and/or the projects.

The monitoring module 208 may be used to monitor or compare the planned financial data and,the actual financial data. For example, as the actual financial data is received, the monitoring module 208 may compare the actual financial data to the planned financial data. If there is a discrepancy between the actual financial data and the planned financial data, the monitoring module 208 may prompt a user response, or create an alert. For example, the user may be prompted to check the entry for accuracy, adjust the forecast, or generate a discrepancy report. An alert may also bring the discrepancy to the user's attention directly on the device screen or in any other manner, such as via an email or other alert. The monitoring can occur as the financial data is entered into the system, or anytime thereafter. Since the business process instance is associated with the various nodes included within each of the hierarchical representations and/or the projects, the financial data may be automatically associated with the hierarchical representations and/or the projects when it is associated with each of the business process instances, according to exemplary embodiments.

The operations module 210 may utilize the received financial data according to the assigned business process instance. After the entry of the financial data, the operations module 210 automatically propagates the financial data through the hierarchical representation according to the associated business process instance and the nodes, as discussed herein. For example, forecasts may be automatically updated to reflect a more precise vision of the future according to the actual financial data. Alternatively, a loan payment, or rent payment can be reconciled automatically as the actual financial data is entered into the system.

The analysis module 212 may be used to perform analysis on the financial data. The analysis module 212 may utilize the comparison data from the monitoring module 208 to analyze the financial data. Cash flow analysis and sensitivity analysis may be performed, for example. In one instance, the sensitivity analysis includes a variation analysis of cash flow and income forecasts. The sensitivity analysis may simulate the impact of variations associated with the business process instances on the forecasts. For example, the impact of changes in interest rates in all current and projected loans may be explored with the sensitivity analysis. The sensitivity analysis does not alter posted or settled transactions.

The project module 206 may be used to define one or more projects associated with the business enterprise, as discussed herein. These projects may group certain types of transactions together to enable analysis according to a particular project. Examples of projects may include production orders, service orders, an asset project, or a specific internal project. Each of the projects may optionally include one or more nodes and the business process instances may be associated with the project, and/or the nodes, as discussed herein.

The status module 214 may be used to associate a status mode with the financial data. The status modes enable the user to assign a status to the financial data. Examples of status modes may be planned, forecasted, ordered, posted, or paid. The user may then view the financial data according to a particular status mode. In other words, the financial data may be grouped according to the status mode.

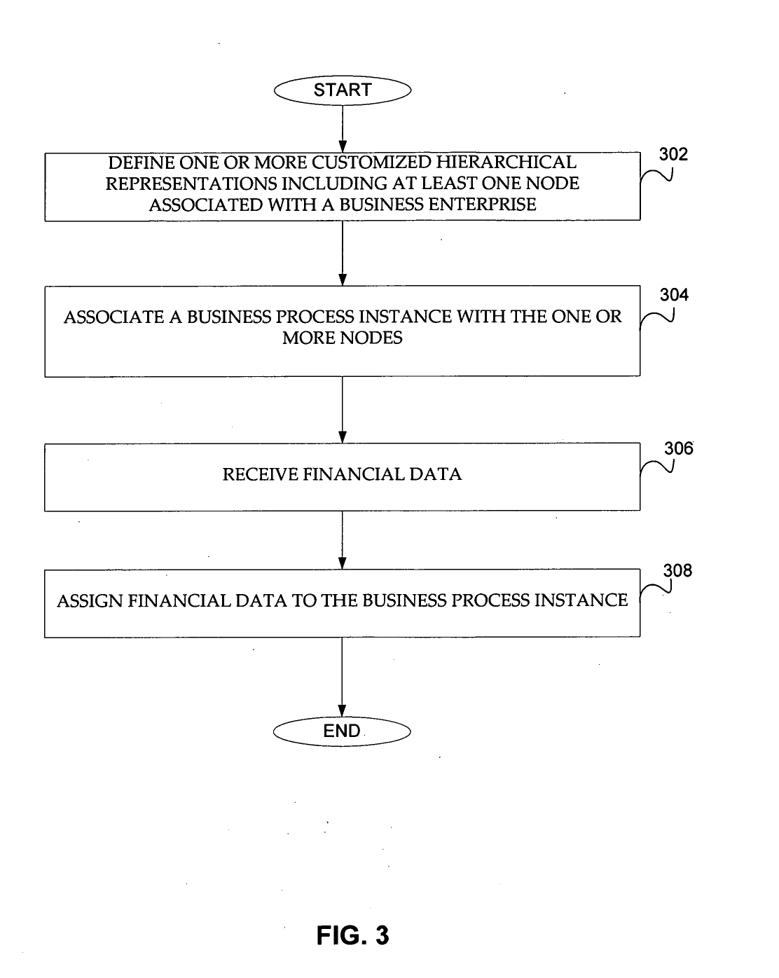

FIG. 3 is a flowchart of an exemplary method for enterprise financial information management. At step 302, one or more customized hierarchical representations including at least one node associated with a business enterprise are defined. The hierarchical representations may be defined for the business enterprise, departments associated with the business enterprise, and/or for any other aspect of the business enterprise. The hierarchical representation may be updated anytime by adding and removing nodes, or by changing node relationships within the hierarchical representation. As discussed herein, one or more projects may also be defined in association with the business enterprise.

At step 304, a business process instance is associated with the one or more nodes associated with one or more customized hierarchical representations, discussed herein. The business process instance may characterize the planned and the actual financial data to be associated with the nodes, such as payroll associated with the Palo Alto, Calif. store branch.

At step 306 the financial data is received. The financial data may consist of the planned financial data and/or the actual financial data, as discussed herein. As the actual financial data is received, it may be used to replace the planned financial data for each entry. According to some embodiments, the planned financial data may be received initially, when the business process instances are defined and associated with the one or more defined customized hierarchical representations.

As discussed herein, as actual financial data is received, it may be compared to the planned financial data. If there is a difference between the actual financial data and the planned financial data, the system may prompt a user response. The financial data comparison and/or user response may be associated with a project to enable analysis according to a particular project, as discussed herein.

At step 308, the received financial data is assigned to a business process instance, such as the business process instances discussed herein. According to exemplary embodiments, the financial data is automatically assigned to the nodes in the hierarchical representations and/or the projects by virtue of the associations of the business process instances to such hierarchical representations and/or the projects.

As discussed herein, the operations module 210 may utilize'the financial data according to the assigned business process instance. The entry of the financial data automatically propagates through the hierarchical representation according to the assignment of the business process instance and the node dependencies. For example, forecasts may be automatically updated to reflect a more precise vision of the future according to the actual financial data. Each business process instance may have one or more transactions with various installments associated with each transaction and various payments effected for each installment, providing flexibility for installment type transactions.

FIG. 4 is a block diagram of an exemplary customized hierarchical representation 400. The blocks 402 through 432 in the hierarchical representation represent the nodes. The customized hierarchical structure is created by the user to represent the manner in which user wants to manage the financial information of the business enterprise. Blocks for the commercial department 402, the financial department 404, the engineering department 406, and the production department 408 have been defined by the user. Arrows branching from the commercial department 402 indicate that a north zone 410, a center zone 412, and a west zone 414 are dependent nodes of the commercial department 402. Further levels of dependencies can be created. For example, a San Francisco store 430 and a Los Angeles store 432 are nodes dependent to west zone 414. Although the example shows only a 3-tier hierarchy, such representations can continue to an n-tier hierarchy as required by the user.

As discussed herein, the hierarchical representations, such as the hierarchical representations shown in FIG. 4, may be selected from a predefined menu. For example, typical hierarchical representations for a retail clothing enterprise may be suggested or provided. The user may utilize the existing typical hierarchical representation provided. Alternatively, the user may modify the existing typical hierarchical representation provided, such as by generating different zones or retail store groupings. As another alternative, the user may create the hierarchical representation by inputting definitions in order to generate one or more hierarchical representations unique to the business enterprise associated with the user.

In other words, the user may add, delete, and modify the hierarchical representations as necessary in order to establish the desired hierarchical representations. The user may also modify nodes that may be suggested or provided in association with predefined hierarchical representations and/or predefined projects. Such modifications can be made at anytime. For example, the changes can be made during the initial hierarchical representation creation. Later on, if the business enterprise undergoes reorganization, or there is a desire to manage the financial information differently, the hierarchical structure can be modified to model changes to the business enterprise.

The hierarchical representation may also be displayed in outline form. The user may choose to view the hierarchical representation in either the tree format of FIG. 4 or an outline form and switch between either display type at any time. All modifications to the hierarchical structure available in the tree display mode may also be available in the outline mode.

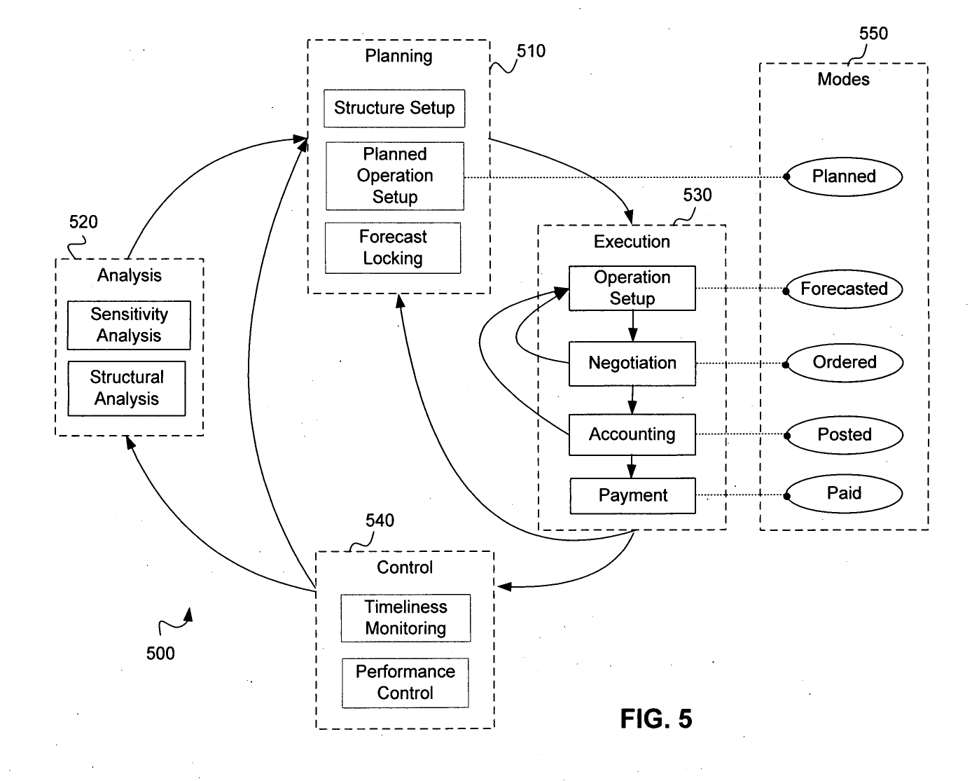

FIG. 5 is an exemplary block diagram depicting exemplary stages of a business process instance. The business process instance stages may include planning, execution, control, and analysis. The planning stage 510 may include structure setup, planned operation setup, and forecast locking. The execution stage 530 may include operation setup, negotiation, accounting, and payment. The control stage 640 may include timeliness monitoring and performance control. The analysis stage 620 may include sensitivity analysis and structural analysis. Modes 550 depict the status classification that may be assigned to the financial data as described herein.

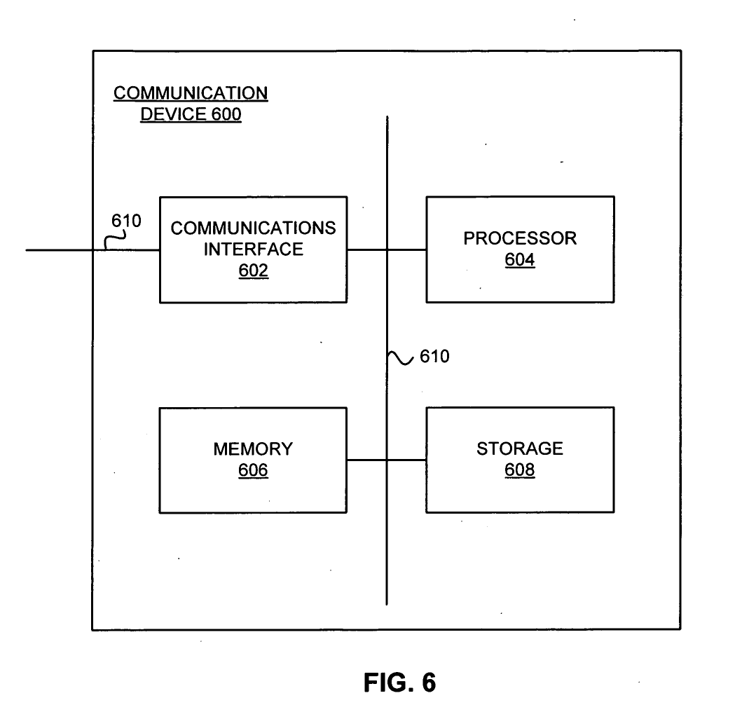

FIG. 6 is a block diagram of an exemplary Computing Device 600 that may be used. The Computing Device 600 may be used to run the financial management engine 106 and the devices 102 associated with the users. The Computing Device 600 includes a Communications Interface 602, a Processor 604, a Memory 606, and Storage 608, which are all coupled to the Bus 610. The Bus 610 provides communications between the Communications Interface 602, the Processor 604, the Memory 606, and the Storage 608.

The Processor 604 executes instructions. The Memory 606 permanently or temporarily stores data. Some examples of the Memory 606 are RAM and ROM. The Storage 608 also permanently or temporarily stores data. Some examples of the Storage 608 are hard disks and disk drives.

The embodiments of Computing Device 600 discussed herein are illustrative. As these embodiments are described with reference to illustrations, various modifications or adaptations of the methods and/or specific structures described may become apparent to those skilled in the art. The above-described components and functions can be comprised of instructions that are stored on a computer-readable storage medium. The instructions can be retrieved and executed by a processor. Some examples of instructions are software, program code, and firmware. Some examples of storage medium are memory devices, tape, disks, integrated circuits, and servers. The instructions are operational when executed by the processor to direct the processor to operate in accord with the invention. Those skilled in the art are familiar with instructions, processor(s), and storage medium.

While various embodiments have been described above, it should be understood that they have been presented by way of example only, and not limitation. For example, any of the elements associated with the financial management engine 106 may employ any of the desired functionality set forth hereinabove. Thus, the breadth and scope of a preferred embodiment should not be limited by any of the above-described exemplary embodiments.

What is claimed is:

1. A method comprising:
defining one or more customized hierarchical representations associated with a business enterprise, wherein the one or more customized hierarchical representations includes one or more nodes;
associating a business process instance with the one or more nodes;
receiving financial data; and
assigning the financial data to the business process instance.

2. The method recited in claim 1, further comprising defining one or more projects associated with the business enterprise.

3. The method recited in claim 1, wherein the financial data comprises planned financial data.

4. The method recited in claim 1, wherein the financial data comprises actual financial data.

5. The method recited in claim 1, further comprising comparing actual financial data associated with a business process instance to planned financial data associated with the business process instance.

6. The method recited in claim 1, further comprising analyzing the financial data.

7. The method recited in claim 1, further comprising associating a status mode with the financial data.

8. The method recited in claim 1, further comprising replacing the planned financial data with the actual financial data.

9. The method recited in claim 1, further comprising associating a business process instance with the one or more projects.

10. The method recited in claim 1, further comprising validating the actual financial data based on the planned financial data and the actual financial data from the past.

11. A computer-readable medium having embodied thereon a computer program, the computer program providing instructions for a method, the method comprising:
defining one or more customized hierarchical representations associated with a business enterprise, wherein each of the one or more customized hierarchical representations includes one or more nodes;
associating a business process instance with the one or more nodes;
receiving financial data; and
assigning the financial data to the business process instance.

12. The computer' readable medium recited in claim 11, further comprising defining one or more projects associated with the business enterprise.

13. The computer readable medium recited in claim 11, wherein the financial data comprises planned financial data.

14. The computer readable medium recited in claim 11, wherein the financial data comprises actual financial data.

15. The computer readable medium recited in claim 11, further comprising comparing actual financial data associated with a business process instance to planned financial data associated with the business process instance.

16. The computer readable medium recited in claim 11, further comprising analyzing the financial data.

17. The computer readable medium recited in claim 11, further comprising associating a status mode with the financial data.

18. The computer readable medium recited in claim 11, further comprising replacing the planned financial data with the actual financial data.

19. The computer readable medium recited in claim 11, further comprising associating a business process instance with one or more projects.

20. The computer readable medium recited in claim 11, further comprising validating actual financial data based on the planned financial data and the actual financial data from the past.

21. A system comprising:
a hierarchical representation module configured to define one or more customized hierarchical representations associated with a business enterprise, the representation module further configured to include one or modes to each of the one or more customized hierarchical representations;
a communications interface configured to receive financial data; and
an operations module configured to associate a business process instance with the one or more nodes, the operation module further configured to assign the financial data to the business process instance.

22. The system recited in claim 21, further comprising a project module configured to define one or more projects associated with the business enterprise.

23. The system recited in claim 21, wherein the financial data comprises planned financial data.

24. The system recited in claim 21, wherein the financial data comprises actual financial data.

25. The system recited in claim 21, further comprising an analysis module configured to compare the actual financial data in a business process instance against the planned financial data.

26. The system recited in claim 21, further comprising an analysis module configured to analyze the financial data.

27. The system recited in claim 21, further comprising a status module configured to associate a status mode with the financial data.

28. The system recited in claim 21, wherein the operations module is further configured to replace the planned financial data with the actual financial data.

29. The system recited in claim 22, wherein the project module is further configured to associate a business process instance with one or more projects.

30. The system recited in claim 21, further comprising an analysis module configured to validate the actual financial data based on the planned financial data and the actual financial data from the past.
